(19) United States
(12) Patent Application Publication
(10) Pub. No.: US 2014/0162932 A1
(43) Pub. Date: Jun. 12, 2014

(54) AQUEOUS LIQUID FRAGRANCE COMPOSITION AND AQUEOUS LIQUID FRAGRANCE USING SAME

(71) Applicants: Tadahide Hatakeyama, Kanagawa (JP); Sadahiko Yamazaki, Kanagawa (JP); Kunihide Hoshino, Kanagawa (JP)

(72) Inventors: Tadahide Hatakeyama, Kanagawa (JP); Sadahiko Yamazaki, Kanagawa (JP); Kunihide Hoshino, Kanagawa (JP)

(73) Assignee: Takasago International Corporation

(21) Appl. No.: 14/234,159

(22) PCT Filed: Jul. 9, 2012
(86) PCT No.: PCT/JP2012/067474

§ 371 Date: Jan. 22, 2014

(30) Foreign Application Priority Data
Jul. 26, 2011 (JP) 2011-163083

(51) Int. Cl. C11B 9/00

(52) U.S. Cl. CPC C11B 9/00
USPC 512/2

(57) ABSTRACT

The present invention provides an aqueous liquid fragrance composition which contains a fragrance, gluconate, an anionic surfactant, a non-ionic surfactant and water, the sum of the amounts of the anionic surfactant and the non-ionic surfactant contained per 1 part by weight of the fragrance being 0.3 to 1.4 parts by weight, and also provides an aqueous liquid fragrance using the same. By containing gluconate, an anionic surfactant and a non-ionic surfactant in an aqueous liquid fragrance composition, this composition of the present invention makes it possible to reduce the amount of a surfactant for solubilizing the fragrance in water. In the present invention, reducing the amount of a surfactant for solubilizing the fragrance in water makes it possible to provide an aqueous liquid fragrance composition and aqueous liquid fragrance using the same whereby favorable volatility can be upheld during use, transparency can be maintained, and the appearance will not be adversely affected.

### TECHNICAL FIELD

The present invention relates to an aqueous liquid fragrance composition in which the amount of a surfactant used for solubilizing a fragrance in water is reduced, and specifically relates to an aqueous liquid fragrance composition in which, by reducing the amount of a surfactant, good volatility can be stably maintained during use and transparency of the composition can be maintained. The present invention further relates to an aqueous liquid fragrance made by housing the aqueous liquid fragrance composition in a suction and volatilization type fragrance device.

### BACKGROUND ART

In order to reduce discomfort due to odor in a living space such as a room, an entrance, a bathroom and a car and to provide a scent, air fresheners in which a fragrance is blended are widely used. Various forms of air fresheners such as a liquid, a gel, a solid and an aerosol are known. Among these forms, liquid type air fresheners can be roughly classified into the aqueous air freshener, the alcoholic air freshener and the oil-soluble air freshener, and these are utilized together with a spray type fragrance device or a suction and volatilization type fragrance device. Aqueous liquid fragrance compositions are widely used because such compositions have low inflammability and are advantageous in terms of the cost. Since many fragrances are hardly soluble in water, in aqueous liquid fragrance compositions, it is required to solubilize a fragrance using a surfactant. However, since surfactants are non-volatile, when the amount of the surfactant is larger, the surfactant is accumulated in a fragrance device during use to inhibit volatilization of the fragrance, and it adversely affects generation of scent and fragrance durability.

In order to solve the above-described problem, some methods for reducing the amount of a surfactant blended in an aqueous liquid fragrance composition have been proposed.

For example, in Patent Document 1 (Japanese Laid-Open Patent Publication No. 2009-261929), it is described that the amount of a surfactant can be reduced by using: i) a method for nanoemulsifying an aqueous liquid fragrance composition comprising a fragrance, a surfactant and an aqueous solvent by utilizing the ultrasonic treatment and/or the high-pressure emulsifying treatment, etc.; ii) a method in which a concentrated solution comprising a fragrance, a surfactant and an aqueous solvent is prepared and then the concentrated solution is mixed with and dissolved in an aqueous solvent; or iii) a method in which i) and ii) above are combined together. However, the methods in i) and iii) above have problems of the cost of production facilities and versatility because special machines are required at the time of the production of a fragrance composition.

In Patent Document 2 (Japanese Laid-Open Patent Publication No. 2007-130083), a method in which ion of a metal such as silver, zinc, copper, aluminium, iron, nickel, tin and lead is contained in an aqueous liquid fragrance composition is proposed. In Patent Document 2, the metal ion is added for the purpose of imparting the deodorization effect and the antibacterial effect to the aqueous liquid fragrance composition. However, attention is not focused on reduction of the content of a surfactant. Further, the preferred amount of the metal ion is about 0.01 to 60 ppm, which is too small, and therefore, the effect of reducing the amount of the surfactant cannot be expected.

Patent Document 3 (Japanese National-phase PCT Laid-Open Patent Publication No. 2008-534043) describes that the amount of a surfactant can be reduced by using a solubilizing-aid such as a C2-C7 linear, branched or cyclic mono-, di- or tri-carboxylic acid in combination with the surfactant in an aqueous liquid fragrance composition. However, when a salt of sodium, potassium, calcium or the like, as a solubilizing-aid, is contained in a liquid composition as recited in claim 16 of Patent Document 3, water and a fragrance are volatilized while the surfactant and the salt that are non-volatile components are concentrated during use, and the balance of solubilization is lost over time. As a result, transparency of the fragrance liquid may be impaired and a white turbidity and separation may be caused.

### PRIOR ART DOCUMENTS

### Patent Documents

Patent Document 1: Japanese Laid-Open Patent Publication No. 2009-261929
Patent Document 2: Japanese Laid-Open Patent Publication No. 2007-130083
Patent Document 3: Japanese National-phase PCT Laid-Open Patent Publication No. 2008-534043

### SUMMARY OF THE INVENTION

### Problems to be Solved by the Invention

Under the above-described circumstances, it is desired to provide an aqueous liquid fragrance composition, in which good volatility is maintained during use and transparency can also be maintained with no poor appearance caused.

### Means for Solving the Problems

The present inventors diligently made researches in order to solve the above-described problems, and found that, by using an anionic surfactant and a non-ionic surfactant in combination with a gluconate at the time of solubilizing a fragrance in water, even if the amount of the surfactant is reduced, the fragrance is stably maintained in an aqueous medium without white turbidity and phase separation, good volatility is maintained during use, and transparency of an aqueous liquid fragrance composition is also maintained. Thus, the present invention was achieved.

Specifically, the present invention relates to an aqueous liquid fragrance composition, an aqueous liquid fragrance made by housing the composition in a suction and volatilization type fragrance device and the like as described below.

[1] An aqueous liquid fragrance composition, which comprises a fragrance, a gluconate, an anionic surfactant, a non-ionic surfactant and water, wherein the sum of the contents of the anionic surfactant and the non-ionic surfactant per 1 part by weight of the fragrance is 0.3 to 1.4 parts by weight.
[2] The composition according to item [1], wherein the gluconate is zinc gluconate.
[3] The composition according to item [1] or [2], wherein the content of the gluconate in the composition is 0.01 to 2 wt %.
[4] The composition according to any one of items [1] to [3], wherein the content of the anionic surfactant in the composition is 0.05 to 20 wt %.
[5] The composition according to any one of items [1] to [4], wherein the anionic surfactant is dialkyl sulfosuccinate.
[6] The composition according to any one of items [1] to [5], wherein the content of the fragrance in the composition is 0.1 to 30 wt %.
[7] An aqueous liquid fragrance made by housing the composition according to any one of items [1] to [6] in a container having a liquid absorption part and a volatilization part.

### Advantageous Effect of the Invention

According to the present invention, it is possible to provide an aqueous liquid fragrance composition, in which good volatility is maintained during use and transparency is also maintained. Further, according to the present invention, it is possible to provide an aqueous liquid fragrance made by housing the composition in a suction and volatilization type fragrance device. According to a preferred embodiment of the present invention, it is possible to provide an aqueous liquid fragrance with a high level of consumer satisfaction, because the quality and strength of fragrance at the start of use is maintained longer than conventional products and transparency of the composition is maintained with no poor appearance caused during use. The aqueous liquid fragrance composition of the present invention can be produced using a simplified method, and raw materials thereof are inexpensive, and therefore the composition is industrially advantageous.

### BRIEF DESCRIPTION OF THE DRAWINGS

FIG. 1 is a graph showing results of the volatilization test of the compositions prepared in Example 6 and Comparative Example 11.

### BEST MODE FOR CARRYING OUT THE INVENTION

Hereinafter, the aqueous liquid fragrance composition, the aqueous liquid fragrance, etc. of the present invention will be specifically described.

The aqueous liquid fragrance composition of the present invention comprises a fragrance, a gluconate, an anionic surfactant, a non-ionic surfactant and water, wherein the sum of the contents of the anionic surfactant and the non-ionic surfactant per 1 part by weight of the fragrance is 0.3 to 1.4 parts by weight. In the aqueous liquid fragrance composition of the present invention, the anionic surfactant and the non-ionic surfactant are used in combination and the gluconate is further contained, thereby reducing the blending amount of the surfactant required for solubilizing the fragrance in water.

Examples of the gluconate to be used in the present invention include a potassium salt, a sodium salt, a calcium salt, a magnesium salt, a manganese salt, a zinc salt and a copper salt. One or more can be selected from these substances and used. Among them, zinc gluconate is preferred on the point that transparency can be more suitably maintained thereby at the time of use.

The content of the gluconate in the composition is preferably 0.01 to 2 wt %. When the content of the gluconate is less than 0.01 wt %, the effect of reducing the blending amount of a surfactant while maintaining good volatility and appearance of the aqueous liquid fragrance composition may not be sufficiently exerted. Further, when the content of the gluconate is more than 2 wt %, a fragrance may not be solubilized, or even if the fragrance can be solubilized, there is a case where an insoluble matter is precipitated or a solution becomes cloudy at the time of use. The amount of the gluconate in the composition is more preferably 0.03 wt % or more, and even more preferably 0.05 wt % or more. Further, the amount of the gluconate in the composition is more preferably 1.8 wt % or less, and even more preferably 1.5 wt % or less.

Examples of the anionic surfactant to be used in the present invention include alkyl sulfate, polyoxyethylene alkyl ether sulfate, alkyl benzene sulfonate, dialkyl sulfosuccinate (e.g., sodium dioctyl sulfosuccinate), N-acyl amino acid salt, alkyl ether carboxylate, sulfonate, alkyl phosphate, polyoxyethylene alkyl ether phosphate and a fatty acid soap. One or more can be selected from these substances and used.

Among them, dialkyl sulfosuccinate is preferred. As the alkyl group of dialkyl sulfosuccinate, a linear or branched alkyl group having 4 to 10 carbon atoms is preferred. For example, a nonyl group, a pentyl group (amyl group), an octyl group, a cyclohexyl group, an ethylhexyl group, a heptyl group, a hexyl group, an isobutyl group, etc. are preferred. Examples of the counterion of dialkyl sulfosuccinate include sodium ion, potassium ion and ammonium ion. Among them, sodium ion is preferred.

Specific examples of dialkyl sulfosuccinate include diisobutyl sodium sulfosuccinate, dioctyl sodium sulfosuccinate, dihexyl sodium sulfosuccinate, diamyl sodium sulfosuccinate and dicyclohexyl sodium sulfosuccinate. Among them, dioctyl sodium sulfosuccinate is preferred.

The content of the anionic surfactant in the composition is preferably 0.05 to 20 wt %. When the content of the anionic surfactant is less than 0.05 wt %, it may be insufficient for solubilizing a fragrance in water. Further, when the content of the anionic surfactant is more than 20 wt %, the amount of the non-volatile matter is too much, and it may inhibit volatilization of the fragrance at the time of use. The amount of the anionic surfactant in the composition is more preferably 0.08 wt % or more, and even more preferably 0.1 wt % or more. Further, the amount of the anionic surfactant in the composition is more preferably 18 wt % or less, and even more preferably 15 wt % or less.

Examples of the non-ionic surfactant to be used in the present invention include polyoxyethylene alkyl ether, polyoxyethylene polyoxypropylene alkyl ether, polyoxyethylene hydrogenated castor oil, alkyl alkanolamide, alkyl polyglucoside, glycerine fatty acid ester, polyglycerol fatty acid ester, polyoxyethylene glycerine fatty acid ester, sorbitan fatty acid ester, polyoxyethylene sorbitan fatty acid ester, polyoxyethylene sorbit fatty acid ester and polyoxyethylene polyoxypropylene glycol. One or more can be selected from these substances and used.

Among them, polyoxyethylene alkyl ether, polyoxyethylene polyoxypropylene alkyl ether and polyoxyethylene hydrogenated castor oil are preferred. In particular, a polyoxyethylene alkyl ether in which the addition molar number of ethylene oxide is 5 to 30, a polyoxyethylene polyoxypropylene alkyl ether in which the addition molar number of each of ethylene oxide and propylene oxide is 5 to 20, and a polyoxyethylene hydrogenated castor oil in which the addition molar number of ethylene oxide is 10 to 100 are preferred.

The content of the non-ionic surfactant in the composition is preferably 0.1 to 20 wt %. When the content of the non-ionic surfactant is less than 0.1 wt %, it may be insufficient for solubilizing a fragrance. Further, when the content of the non-ionic surfactant is more than 20 wt %, the amount of the non-volatile matter is too much, and it may inhibit volatilization of the fragrance at the time of use.

The fragrance to be used in the present invention is not particularly limited as long as it can be used for an air freshener. Examples of the fragrance include publicly-known synthetic fragrances and natural fragrances described, for examples, in the following documents: “Perfume and Flavor Chemicals”, Vol. I and II, Steffen Arctander, Allured Pub. Co. (1994); “Synthetic Perfume, Chemistry and Product Information”, Motoichi Indo, The Chemical Daily Co., Ltd. (1996); “Encyclopedia of Fragrances”, Japan Perfumery & Flavoring Association Ed., Asakura Publishing Co., Ltd. (1989); “Perfumery Material Performance V. 3.3”, Boelens Aroma Chemical Information Service (1996); and “Flower oils and Floral Compounds In Perfumery”, Danute Lajaujis Anonis, Allured Pub. Co. (1993).

Specifically, esters, alcohols, aldehydes, ketones, acetals, phenols, ethers, lactones, furans, hydrocarbons, acids, natural fragrances, etc. can be used.

Examples of the esters to be used include acrylic acid esters (methyl, ethyl, etc.), acetoacetic acid esters (methyl, ethyl, etc.), anisic acid esters (methyl, ethyl, etc.), benzoic acid esters (allyl, isoamyl, ethyl, geranyl, linalyl, phenylethyl, hexyl, cis-3-hexenyl, benzyl, methyl, etc.), anthranilic acid esters (cinnamyl, cis-3-hexenyl, methyl, ethyl, linalyl, isobutyl, etc.), N-methylanthranilic acid esters (methyl, ethyl, etc.), isovaleric acid esters (amyl, allyl, isoamyl, isobutyl, isopropyl, ethyl, octyl, geranyl, cyclohexyl, citronellyl, terpenyl, linalyl, cinnamyl, phenylethyl, butyl, propyl, hexyl, benzyl, methyl, rhodinyl, etc.), isobutyric acid esters (isoamyl, geranyl, citronellyl, terpenyl, cinnamyl, octyl, nellyl, phenylethyl, phenylpropyl, phenoxyethyl, butyl, propyl, isopropyl, hexyl, benzyl, methyl, ethyl, linalyl, rhodinyl, etc.), undecylenic acid esters (allyl, isoamyl, butyl, ethyl, methyl, etc.), octanoic acid esters (allyl, isoamyl, ethyl, octyl, hexyl, butyl, methyl, linalyl, etc.), octenoic acid esters (methyl, ethyl, etc.), octynecarboxylic acid esters (methyl, ethyl, etc.), caproic acid esters (allyl, amyl, isoamyl, methyl, ethyl, isobutyl, propyl, hexyl, cis-3-hexenyl, trans-2-hexenyl, linalyl, geranyl, cyclohexyl, etc.), hexenoic acid esters (methyl, ethyl, etc.), valeric acid esters (amyl, isopropyl, isobutyl, ethyl, cis-3-hexenyl, trans-2-hexenyl, cinnamyl, phenylethyl, methyl, etc.), formic acid esters (anisyl, isoamyl, isopropyl, ethyl, octyl, geranyl, citronellyl, cinnamyl, cyclohexyl, terpenyl, phenylethyl, butyl, propyl, hexyl, cis-3-hexenyl, benzyl, linalyl, rhodinyl, etc.), crotonic acid esters (isobutyl, ethyl, cyclohexyl, etc.), cinnamic acid esters (allyl, ethyl, methyl, isopropyl, propyl, 3-phenylpropyl, benzyl, cyclohexyl, methyl, etc.), succinic acid esters (monomenthyl, diethyl, dimethyl, etc.), acetic acid esters (anisyl, amyl, α-amylcinnamyl, isoamyl, isobutyl, isopropyl, isobornyl, isoeugenyl, eugenyl, 2-ethylbutyl, ethyl, 3-octyl, p-cresyl, o-cresyl, geranyl, α- or β-santalyl, cyclohexyl, cycloneryl, dihydrocuminyl, dimethyl benzyl carbinyl, cinnamyl, styralyl, decyl, dodecyl, terpenyl, guainyl, neryl, nonyl, phenyl ethyl, phenylpropyl, butyl, furfuryl, propyl, hexyl, cis-3-hexenyl, trans-2-hexenyl, cis-3-nonenyl, cis-6-noneyl, cis-3-cis-6-nonadienyl, 3-methyl-2-butenyl, heptyl, benzyl, bornyl, myrcenyl, dihydromyrcenyl, myrtenyl, methyl, 2-methylbutyl, menthyl, linalyl, rhodinyl, etc.), salicylic acid esters (allyl, isoamyl, phenyl, phenylethyl, benzyl, ethyl, methyl, etc.), cyclohexylalkanoic acid esters (ethyl cyclohexylacetate, allyl cyclohexylpropionate, allyl cyclohexylbutyrate, allyl cyclohexylhexanoate, allyl cyclohexyldecanoate, allyl cyclohexylvalerate, etc.), stearic acid esters (ethyl, propyl, butyl, etc.), sebacic acid esters (diethyl, dimethyl, etc.), decanoic acid esters (isoamyl, ethyl, butyl, methyl, etc.), dodecanoic acid esters (isoamyl, ethyl, butyl, etc.), lactic acid esters (isoamyl, ethyl, butyl, etc.), nonanoic acid esters (ethyl, phenylethyl, methyl, etc.), nonenoic acid esters (allyl, ethyl, methyl, etc.), hydroxyhexanoic acid esters (ethyl, methyl, etc.), phenylacetic acid esters (isoamyl, isobutyl, ethyl, geranyl, citronellyl, cis-3-hexenyl, methyl, etc.), phenoxyacetic acid esters (allyl, ethyl, methyl, etc.), furancarboxylic acid esters (ethyl furancarboxylate, methyl furancarboxylate, hexyl furancarboxylate, isobutyl furanpropionate, etc.), propionic acid esters (anisyl, allyl, ethyl, amyl, isoamyl, propyl, butyl, isobutyl, isopropyl, benzyl, geranyl, cyclohexyl, citronellyl, cinnamyl, tetrahydrofurfuryl, tricyclodecenyl, heptyl, bornyl, methyl, menthyl, linallyl, terpenyl, α-methylpropionyl, β-methylpropionyl, etc.), heptanoic acid esters (allyl, ethyl, octyl, propyl, methyl, etc.), heptinecarboxylic acid esters (allyl, ethyl, propyl, methyl, etc.), myristic acid esters (isopropyl, ethyl, methyl, etc.), phenylglycidic acid esters (ethyl phenylglycidate, ethyl 3-methylphenylglycidate, ethyl p-methyl-β-phenylglycidate, etc.), 2-methylbutyric acid esters (methyl, ethyl, octyl, phenyl ethyl, butyl, hexyl, benzyl, etc.), 3-methylbutyric acid esters (methyl, ethyl, etc.), butyric acid esters (anisyl, amyl, allyl, isoamyl, methyl, ethyl, propyl, octyl, guainyl, linallyl, geranyl, cyclohexyl, citronellyl, cinnamyl, nellyl, terpenyl, phenylpropyl, β-phenylethyl, butyl, hexyl, cis-3-hexenyl, trans-2-hexenyl, benzyl, rhodinyl, etc.), and hydroxybutyric acid esters (methyl, ethyl, menthyl or the like of 3-hydroxybutyric acid esters).

Examples of the alcohols to be used include: aliphatic alcohols (isoamyl alcohol, 2-ethylhexanol, 1-octanol, 3-octanol, 1-octene-3-ol, 1-decanol, 1-dodecanol, 2,6-nonadienol, nonanol, 2-nonanol, cis-6-nonenol, trans-2, cis-6-nonadienol, cis-3, cis-6-nonadienol, butanol, hexanol, cis-3-hexenol, trans-2-hexenol, 1-undecanol, heptanol, 2-heptanol, 3-methyl-1-pentanol, etc.); terpene alcohols (borneol, isoborneol, carveol, geraniol, α- or β-santalol, citronellol, 4-thujanol, terpineol, 4-terpineol, nerol, myrcenol, myrtenol, dihydromyrccnol, tetrahydromyrcenol, nerolidol, hydroxycitronellol, farnesol, perilla alcohol, rhodinol, linalool, etc.); and aromatic alcohols (anisic alcohol, α-amylcinnamic alcohol, isopropylbenzylcarbinol, carvacrol, cumin alcohol, dimethylbenzylcarbinol, cinnamic alcohol, phenyl allyl alcohol, phenylethylcarbinol, β-phenylethyl alcohol, 3-phenylpropyl alcohol, benzyl alcohol, etc.).

Examples of the aldehydes to be used include: aliphatic aldehydes (acetaldehyde, octanal, nonanal, decanal, undecanal, 2,6-dimethyl-5-heptanal, 3,5,5-trimethylhexanal, cis-3, cis-6-nonadienal, trans-2, cis-6-nonadienal, valeraldehyde, propanal, isopropanal, hexanal, trans-2-hexenal, cis-3-hexenal, 2-pentenal, dodecanal, tetradecanal, trans-4-decenal, trans-2-tridecenal, trans-2-dodecenal, trans-2-undecenal, 2,4-hexadienal, cis-6-nonenal, trans-2-nonenal, 2-methylbutanal, etc.); aromatic aldehydes (anisic aldehyde, α-amylcinnamic aldehyde, α-methylcinnamic aldehyde, cyclamen aldehyde, p-isopropylphenylacetaldehyde, ethylvanillin, cumin aldehyde, salicylaldehyde, cinnamic aldehyde, o-, m- or p-tolylaldehyde, vanillin, piperonal, phenylacetaldehyde, heliotropin, benzaldehyde, 4-methyl-2-pheny-2-pentenal, p-methoxycinnamic aldehyde, p-methoxybenzaldehyde, etc.); and terpene aldehydes (geranial, citral, citronellal, α-sinensal, β-sinensal, perillaldehyde, hydroxycitronellal, tetrahydrocitral, myrtenal, cyclocitral, isocyclocitral, citronellyloxyacetaldehyde, neral, α-methylenecitronellal, myracaldehyde, vernaldehyde, safranal, etc.).

Examples of the ketones to be used include: cyclic ketones (1-acetyl-3,3-dimethyl-1-cyclohexene, cis-jasmone, α-, β- or γ-irone, ethyl maltol, cyclotene, dihydronootkatone, 3,4-dimethyl-1,2-cyclopentadione, sotolon, α-, β-, γ- or δ-damascone, α-, β- or γ-damascenone, nootkatone, 2-sec-butylcyclohexanone, maltol, α-, β- or γ-ionone, α-, β- or γ-methylionone, α-, β- or γ-isomethylionone, furaneol, camphor, etc.); aromatic ketones (acetonaphthone, acetophenone, anisylideneacetone, raspberry ketone, p-methyl acetophenone, anisylacetone, p-methoxy acetophenone, etc.); and chain ketones (diacetyl, 2-nonanone, diacetyl, 2-heptanone, 2,3-heptanedione, 2-pentanone, methyl amyl ketone, methyl nonyl ketone, β-methyl naphthyl ketone, methyl heptanone, 3-heptanone, 4-heptanone, 3-octanone, 2,3-hexanedione, 2-undecanone, dimethyloctenone, 6-methyl-5-hepten-2-one, etc.).

Examples of the acetals to be used include acetaldehyde diethyl acetal, acetaldehyde diamyl acetal, acetaldehyde dihexyl acetal, acetaldehyde propylene glycol acetal, acetaldehyde ethyl cis-3-hexenyl acetal, benzaldehyde glycerin acetal, benzaldehyde propylene glycol acetal, citral dimethyl acetal, citral diethyl acetal, citral propylene glycol acetal, citral ethylene glycol acetal, phenylacetaldehyde dimethyl acetal, citronellyl methyl acetal, acetaldehyde phenylethylpropyl acetal, hexanal dimethyl acetal, hexanal dihexyl acetal, hexanal propylene glycol acetal, trans-2-hexenal diethyl acetal, trans-2-hexenal propylene glycol acetal, cis-3-hexenal diethyl acetal, heptanal diethyl acetal, heptanal ethylene glycol acetal, octanal dimethyl acetal, nonanal dimethyl acetal, decanal dimethyl acetal, decanal diethyl acetal, 2-methylundecanal dimethyl acetal, citronellal dimethyl acetal, Ambersage (manufactured by Givaudan), ethyl acetoacetate ethylene glycol acetal and 2-phenylpropanal dimethyl acetal.

Examples of the phenols to be used include eugenol, isoeugenol, 2-methoxy-4-vinylphenol, thymol, carvacrol, guaiacol and chavicol.

Examples of the ethers to be used include anethole, 1,4-cineole, dibenzyl ether, linalool oxide, limonene oxide, nerol oxide, rose oxide, methyl isoeugenol, methyl chavicol, isoamyl phenyl ethyl ether, β-naphtyl methyl ether, phenyl propyl ether, p-cresyl methyl ether, vanillyl butyl ether, α-terpinyl methyl ether, citronellyl ethyl ether, geranyl ethyl ether, rosefuran, theaspirane, decylmethyl ether and methylphenyl methyl ether.

Examples of the lactones to be used include γ- or δ-decalactone, γ-heptalactone, γ-nonalactone, γ- or δ-hexylactone, γ- or δ-octalactone, γ- or δ-undecalactone, δ-dodecalactone, δ-2-decenolactone, methyl lactone, 5-hydroxy-8-undecenoic acid δ-lactone, jasmine lactone, menthalactone, dihydrocoumarin, octahydrocoumarin and 6-methylcoumarin.

Examples of the furans to be used include furan, 2-methylfuran, 3-methylfuran, 2-ethylfuran, 2,5-diethyltetrahydrofuran, 3-hydroxy-2-methyltetrahydrofuran, 2-(methoxymethyl)furan, 2,3-dihydrofuran, furfural, 5-methylfurfural, 3-(2-furyl)-2-methyl-2-propenal, 5-(hydroxymethyl)furfural, 2,5-dimethyl-4-hydroxy-3(2H)-furanone (furaneol), 4,5-dim ethyl-3-hydroxy-2(5H)-furanone (sotolon), 2-ethyl-4-hydroxy-5-methyl-3(2H)-furanone (homofuraneol), 5-ethyl-3-hydroxy-4-methyl-2(5H)-furanone (homosotolon), 3-methyl-1,2-cyclopentanedione (cyclotene), 2(5H)-furanone, 4-methyl-2(5H)-furanone, 5-methyl-2(5H)-furanone, 2-methyl-3(2H)-furanone, 5-methyl-3(2H)-furanone, 2-acetylfuranone, 2-acetyl-5-methylfuran, furfuryl alcohol, methyl 2-furancarboxylate, ethyl 2-furancarboxylate and furfuryl acetate.

Examples of the hydrocarbons to be used include α- or β-bisabolene, β-caryophyllene, p-cymene, terpinene, terpinolene, cadinene, farnesene, limonene, ocimene, myrcene, α- or β-pinene, 1,3,5-undecatriene and valencene.

Examples of the acids to be used include geranic acid, dodecanoic acid, myristic acid, stearic acid, lactic acid, phenylacetic acid, pyruvic acid, trans-2-methyl-2-pentenoic acid, 2-methyl-cis-3-pentenoic acid, 2-methyl-4-pentenoic acid and cyclohexanecarboxylic acid.

Examples of the natural fragrances to be used include anise, orange, lemon, lime, mandarin, petitgrain, bergamot, lemon balm, grapefruit, elemi, olibanum, lemongrass, neroli, marjoram, angelica root, star anise, basil, bay, calamus, chamomile, caraway, cardamom, cassia, cinnamon, pepper, perilla, cypress, oregano, cascarilla, ginger, parsley, pine needle, sage, hyssop, tea tree, mustard, horseradish, clary sage, clove, cognac, coriander, estragon, eucalyptus, fennel, guaiac wood, dill, cajuput, wormseed, pimento, juniper, fenugreek, garlic, laurel, mace, myrrh, nutmeg, spruce, geranium, citronella, lavender, lavandin, palmarosa, rose, rosemary, sandalwood, oakmoss, cedarwood, vetiver, linaloe, bois de rose, patchouli, labdanum, cumin, thyme, ylang ylang, birch, capsicum, celery, tolu balsam, genet, immortelle, benzoin, jasmine, cassie, tuberose, reseda, marigold, mimosa, opoponax, orris, vanilla and licorice. In addition, fragrance components contained in these natural fragrances can be extracted and used.

These fragrances may be used solely, and alternatively, any two or more of them can be used in combination and blended. The content of the fragrance in the composition cannot be categorically described because it varies depending on the type of a fragrance used, etc., but the content is usually preferably 0.1 to 30 wt %. When the content of the fragrance is too small, a sufficient strength of the scent may not be obtained. Further, when the content of the fragrance is too large, it leads to a larger content of the surfactant for solubilizing the fragrance, and it may inhibit volatilization of the fragrance at the time of use. It is desirable to suitably select the content of the fragrance depending on the type of a fragrance used, etc. in view of the above-described points.

In order to diminish adverse effects on volatilization of the fragrance at the time of use due to increase in the concentration of the surfactant and adverse effects on enhancing diffusivity of scent and fragrance durability, the blending amount of the anionic surfactant and the non-ionic surfactant per 1 part by weight of the fragrance is desirably as small as possible. In the present invention, the sum of the contents of the anionic surfactant and the non-ionic surfactant per 1 part by weight of the fragrance is 0.3 to 1.4 parts by weight. Regarding the preferred range of the sum of the contents of the anionic surfactant and the non-ionic surfactant per 1 part by weight of the fragrance, the sum is preferably as small as possible, and it cannot be categorically described because it varies depending on the type or content of a fragrance, but the sum is preferably 1.2 parts by weight or less, and more preferably 1 part by weight or less. By adjusting the sum of the contents of the anionic surfactant and the non-ionic surfactant per 1 part by weight of the fragrance within the above-described range, the fragrance can be solubilized in water with transparency while the appearance of the composition is not adversely affected during use. When the sum of the contents of the anionic surfactant and the non-ionic surfactant per 1 part by weight of the fragrance is less than 0.3 parts by weight, the fragrance cannot be solubilized with transparency. Further, when the sum is more than 1.4 parts by weight, since the reduced amount of the surfactant is too small, effects exerted by reducing the surfactant cannot be sufficiently obtained. In addition, when the sum is more than 1.4 parts by weight, since the reduced amount of the surfactant is too small, sufficient effects of improving the strength of the scent and fragrance durability cannot be obtained.

According to need, in addition to the above-described components, other components may also be blended in the aqueous liquid fragrance composition of the present invention within a range in which the effects of the present invention are not reduced.

For example, a water-soluble organic solvent may be blended in the composition. Examples of the water-soluble organic solvent include ethanol, propanol, isopropanol, butanol, 3-methoxy-3-methyl-1-butanol, benzyl alcohol, ethyl carbitol (diethylene glycol monoethyl ether), ethylene glycol, propylene glycol, dipropylene glycol, butylene glycol, hexylene glycol, glycerin, ethylene glycol monomethyl ether, propylene glycol monomethyl ether, propylene glycol monoethyl ether and dipropylene glycol monomethyl ether. These water-soluble solvents may be used solely or in combination. The content of the water-soluble organic solvent in the composition should be suitably determined depending on purposes, but is usually preferably 0 to 60 wt %.

Further, according to need, an oil-soluble organic solvent may be blended in the composition. Examples of the oil-soluble organic solvent include isoparaffin, paraffin, limonene, pinene, triethyl citrate, benzyl benzoate, isopropyl myristate, triacetin and silicon.

Moreover, according to need, a sequestering agent, a preservative, an antioxidant, a deodorizer, a sterilization agent, an ultraviolet absorber, a pH adjuster, a cationic surfactant, an amphoteric surfactant, an insecticidal component, a component for protection from insects, a repellent ingredient, a colorant, etc. may be blended in the composition.

In the present invention, the content of water in the composition corresponds to a portion other than the other components, but is usually preferably 30 to 99.7% by mass.

The aqueous liquid fragrance composition of the present invention can be prepared by mixing the above-described fragrance, gluconate, anionic surfactant, non-ionic surfactant, water and other components (according to need) at a predetermined quantitative ratio. The aqueous liquid fragrance composition of the present invention can be produced using a simplified method of mixing and stirring without any special device.

The aqueous liquid fragrance composition of the present invention can be used in the form of an aqueous liquid fragrance by housing the composition in a container, which has a liquid absorption part for sucking the aqueous liquid fragrance conventionally widely used and a volatilization part for volatilizing the sucked aqueous liquid fragrance. The liquid absorption part and the volatilization part are usually composed of a fibrous material such as: a natural fiber such as plant fiber and pulp; a synthetic fiber such as rayon, polyester, polyethylene terephthalate, polyethylene and polypropylene; or a mixed fiber thereof. For example, containers like those shown in Japanese Laid-Open Patent Publication No. H09-187495 and Japanese Laid-Open Patent Publication No. 2001-225884 can be used. Alternatively, for example, containers having a part in which a liquid absorption part and a volatilization part are integrally formed like those shown in Japanese Laid-Open Patent Publication No. 2003-102825 and Japanese Laid-Open Patent Publication No. 2003-320005 can also be used.

The aqueous liquid fragrance of the present invention can be used in a room, an entrance, a bathroom, a car, etc. By using the aqueous liquid fragrance of the present invention, a desired scent can be provided to a living space.

### EXAMPLES

Hereinafter, the present invention will be specifically described by way of illustrative examples, but the present invention is not limited thereto.

### Examples 1-3 and Comparative Examples 1-5

Aqueous liquid fragrance compositions were prepared according to formulations shown in Table 1. Blending amounts in the table are represented by weight percent.

### <Assessment of Appearance Property>

20 g of each composition prepared was put into a 30 mL glass container, and the appearance property of each composition immediately after blending was confirmed by visual observation according to the below-described assessment criteria. The results are shown in Table 1.

### (Assessment Criteria)

◯ . . . transparent
Δ . . . semi-transparent
X . . . white turbidity, phase separation

TABLE 1
Formulations of aqueous liquid fragrance compositions and appearance property of compositions

| | Examples | | | Comparative Examples | | | | |
|---|---|---|---|---|---|---|---|---|
| Blended components | 1 | 2 | 3 | 1 | 2 | 3 | 4 | 5 |
| Orange-blended fragrance*¹ | 1.5 | 20 | — | 1.5 | 1.5 | 1.5 | 1.5 | — |
| Rose-blended fragrance*² | — | — | 28 | — | — | — | — | 28 |
| Sodium dioctyl sulfosuccinate | 0.7 | 5 | 4.5 | 0.7 | 1.8 | 1.4 | — | 2.5 |
| Polyoxyethylene decyl ether | 0.4 | 3.5 | 2.5 | 0.4 | 1 | — | 0.8 | 1.5 |
| Polyoxyethylene hydrogenated castor | 0.3 | 3.5 | 2.5 | 0.3 | 0.8 | — | 0.6 | 1 |
| oil | | | | | | | | |
| 3-methyl-3-methoxy-1-butanol | 1.5 | 15 | 20 | 1.5 | 1.5 | 1.5 | 1.5 | 20 |
| Zinc gluconate | 0.15 | 1.5 | 1.2 | — | — | 0.15 | 0.15 | 1.2 |
| Water | Remaining | Remaining | Remaining | Remaining | Remaining | Remaining | Remaining | Remaining |
| | amount | amount | amount | amount | amount | amount | amount | amount |
| Sum | 100 | 100 | 100 | 100 | 100 | 100 | 100 | 100 |
| Amount of surfactants per 1 part by | 0.93 | 0.6 | 0.34 | 0.93 | 2.4 | 0.93 | 0.93 | 0.18 |
| weight of fragrance (parts by weight) | | | | | | | | |
| Appearance property | ◯ | ◯ | ◯ | X | ◯ | X | X | X |
| (immediately after blending) | | | | | | | | |

*¹Orange-blended fragrance: manufactured by Takasago International Corporation
*²Rose-blended fragrance: manufactured by Takasago International Corporation

As is clear from the results in Table 1, by comparing Example 1 with Comparative Examples 1 and 2, it was found that the blending amount of the surfactant can be reduced by blending zinc gluconate. As shown in Comparative Example 1, when the equal amounts of the same surfactants as those in Example 1 were used without blending zinc gluconate, a white turbidity was yielded in the composition. As shown in Comparative Examples 3 and 4, when the anionic surfactant and the non-ionic surfactant were not used in combination and one of them was used solely, a white turbidity was yielded in the composition. Thus, it was found that transparency of the composition can be maintained by use of a small amount of the surfactant when the anionic surfactant and the non-ionic surfactant are used in combination and the gluconate is further contained at the time of solubilizing the fragrance.

Meanwhile, by comparing Example 3 with Comparative Example 5, it was found that a white turbidity is yielded in the composition when the sum of the contents of the anionic surfactant and the non-ionic surfactant per 1 part by weight of the fragrance for solubilizing the fragrance is too small.

### Examples 4 and 5 and Comparative Examples 6-10

Aqueous liquid fragrance compositions were prepared according to formulations shown in Table 2. Blending amounts in the table are represented by weight percent.

### <Assessment of Appearance Properties>

A 50 mL container for a liquid fragrance having a suction part (mixed fiber of polyethylene and polypropylene, diameter: 10 mm, length: 70 mm) and a volatilization part (cellulose, 60 mm×60 mm×3 mm) was filled with 50 g of each composition prepared, and the composition was volatilized at room temperature. The appearance properties of each composition immediately after blending and 2 and 4 weeks after the initiation of volatilization were confirmed by visual observation according to the below-described assessment criteria. The results are shown in Table 2.

### (Assessment Criteria)

◯ . . . transparent
Δ . . . semi-transparent
X . . . white turbidity, phase separation

TABLE 2
Formulations of aqueous liquid fragrance compositions and appearance properties of compositions

| | Examples | | Comparative Examples | | | | |
|---|---|---|---|---|---|---|---|
| Blended components | 4 | 5 | 6 | 7 | 8 | 9 | 10 |
| Orange-blended fragrance*¹ | 1.5 | — | 1.5 | 1.5 | 1.5 | — | — |
| Peach-blended fragrance*² | — | 1.5 | — | — | — | 1.5 | 1.5 |
| Sodium dioctyl sulfosuccinate | 0.8 | 0.7 | 0.8 | 0.8 | 0.8 | 0.7 | 0.7 |
| Polyoxyethylene decyl ether | 0.4 | 0.4 | 0.4 | 0.4 | 0.4 | 0.4 | 0.4 |
| Polyoxyethylene hydrogenated castor oil | 0.4 | 0.4 | 0.4 | 0.4 | 0.4 | 0.4 | 0.4 |
| 3-methyl-3-methoxy-1-butanol | — | 1.5 | — | — | — | 1.5 | 1.5 |
| 95% ethanol | 1.5 | — | 1.5 | 1.5 | 1.5 | — | — |
| Zinc gluconate | 0.15 | 0.15 | — | — | — | — | — |
| Sodium pyrrolidonecarboxylate | — | — | 0.65 | — | — | — | — |
| Sodium citrate | — | — | — | 0.5 | — | — | — |
| Calcium pantothenate | — | — | — | — | — | 0.15 | — |
| Zinc phenolsulfonate | — | — | — | — | 0.2 | — | — |
| Zinc salicylate | — | — | — | — | — | — | 0.2 |
| Water | Remaining | Remaining | Remaining | Remaining | Remaining | Remaining | Remaining |
| | amount | amount | amount | amount | amount | amount | amount |
| Sum | 100 | 100 | 100 | 100 | 100 | 100 | 100 |
| Amount of surfactants per 1 part by weight of | 1.07 | 1 | 1.07 | 1.07 | 1.07 | 1 | 1 |
| fragrance (parts by weight) | | | | | | | |
| Appearance property (immediately after | ◯ | ◯ | ◯ | ◯ | ◯ | X | ◯ |
| blending) | | | | | | | |
| Appearance property (2 weeks after the | ◯ | ◯ | Δ | ◯ | X | — | ◯ |
| initiation of volatilization) | | | | | | | |
| Appearance property (4 weeks after the | ◯ | ◯ | X | X | X | — | X |
| initiation of volatilization) | | | | | | | |

*¹Orange-blended fragrance: manufactured by Takasago International Corporation
*²Peach-blended fragrance: manufactured by Takasago International Corporation

As is clear from the results in Table 2, in the case of solutions prepared with zinc gluconate blended, transparency thereof was successfully maintained at the time of volatilization (Examples 4 and 5). Meanwhile, in the case of blending an electrolyte or a zinc compound different from zinc gluconate like Comparative Examples 6-8 and 10, even though the amount of the surfactant required for obtaining a transparent appearance immediately after blending was successfully reduced as in the case of using zinc gluconate, a white turbidity and phase separation were caused before the termination of volatilization, and transparency could not be maintained. Further, in the case of blending calcium pantothenate like Comparative Examples 9, a white turbidity was yielded immediately after the preparation of the composition.

### Example 6 and Comparative Example 11

Aqueous liquid fragrance compositions were prepared according to formulations shown in Table 3. Blending amounts in the table are represented by weight percent.

TABLE 3
Formulations of aqueous liquid fragrance compositions

| | | Comparative |
|---|---|---|
| | | Example |
| Blended components | Example 6 | 11 |
| Orange-blended fragrance* | 20 | 20 |
| Sodium dioctyl sulfosuccinate | 4 | 6 |
| Polyoxyethylene decyl ether | 3 | 4.5 |
| Polyoxyethylene hydrogenated castor oil | 3 | 4.5 |
| 3-methyl-3-methoxy-1-butanol | 15 | 15 |
| Zinc gluconate | 1.2 | — |
| Water | Remaining | Remaining |
| | amount | amount |
| Sum | 100 | 100 |
| Amount of surfactants per 1 part by | 0.5 | 0.75 |
| weight of fragrance (parts by weight) | | |
| Amount of surfactants | 10 | 15 |

| | |
|---|---|
| Reduced amount of surfactants | 5 wt % |

*Orange-blended fragrance: manufactured by Takasago International Corporation

A 50 mL container for a liquid fragrance having a suction part (mixed fiber of polyethylene and polypropylene, diameter: 10 mm, length: 70 mm) and a volatilization part (cellulose, 60 mm×60 mm×3 mm) was filled with 50 g of each composition prepared, the composition was volatilized at room temperature, and the volatilization test and the sensory test were conducted as described below.

### <Volatilization Test>

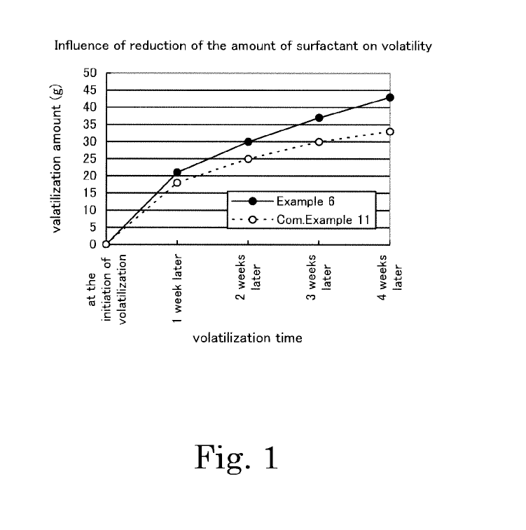

The weight of the liquid fragrance was measured at the time of the initiation of volatilization and 1, 2, 3 and 4 weeks after the initiation of volatilization, and the volatilization amount was determined based on the weight change from the initiation of volatilization. The results are shown in FIG. 1.

As is clear from FIG. 1, the volatilization amount of the composition from the initiation of volatilization to 4 weeks after the initiation in Example 6 was larger than the amount in Comparative Example 11. From the results, it was found that volatility is improved by blending zinc gluconate and reducing the blending amount of the surfactant.

### <Sensory Test>

Each composition was allowed to stand for 20 minutes in a booth for assessment of fragrance, and then the strength of the scent was assessed by 6 expert panelists for assessment according to the below-described assessment criteria. The test was conducted at the time of the initiation of volatilization and 2 and 4 weeks after the initiation of volatilization. The results are shown in Table 4. Note that the results shown in Table 4 are average values of scores of the 6 expert panelists for assessment.

### (Assessment Criteria)

### Strength of the Scent

7: significantly strong
6: strong
5: slightly strong
4: general as a fragrance
3: slightly weak
2: weak
1: significantly weak

TABLE 4
Results of sensory test

| | At the time of the | | |
|---|---|---|---|
| Aqueous liquid fragrance | initiation of | | |
| composition | volatilization | 2 weeks later | 4 weeks later |
| Example 6 | 5 | 4.8 | 4.5 |
| Comparative Example 11 | 4.8 | 4.4 | 3.8 |

As shown in Table 4, the scent from the initiation of volatilization to 4 weeks after the initiation in Example 6 was stronger than that in Comparative Example 11. It was found that not only good volatility is maintained, but also enhancing diffusivity of scent is improved by blending zinc gluconate and reducing the blending amount of the surfactant.

### INDUSTRIAL APPLICABILITY

During use of the aqueous liquid fragrance composition of the present invention, good volatility is maintained and transparency is also maintained with no poor appearance caused, and therefore, the composition is preferably used as an aqueous liquid fragrance. The aqueous liquid fragrance composition of the present invention can be produced using a simplified method, and raw materials thereof are inexpensive, and therefore the composition is industrially advantageous.

1. An aqueous liquid fragrance composition, which comprises a fragrance, a gluconate, an anionic surfactant, a non-ionic surfactant and water, wherein the sum of the contents of the anionic surfactant and the non-ionic surfactant per 1 part by weight of the fragrance is 0.3 to 1.4 parts by weight.

2. The composition according to claim 1, wherein the gluconate is zinc gluconate.

3. The composition according to claim 1, wherein the content of the gluconate in the composition is 0.01 to 2 wt %.

4. The composition according to claim 1, wherein the content of the anionic surfactant in the composition is 0.05 to 20 wt %.

5. The composition according claim 1, wherein the anionic surfactant is dialkyl sulfosuccinate.

6. The composition according to claim 1, wherein the content of the fragrance in the composition is 0.1 to 30 wt %.

7. An aqueous liquid fragrance made by housing the composition according to claim 1 in a container having a liquid absorption part and a volatilization part.
